(19) United States
(12) Patent Application Publication
(10) Pub. No.: US 2011/0050774 A1
(43) Pub. Date: Mar. 3, 2011

(54) Liquid Ejecting Apparatus and Liquid Ejecting Method

(75) Inventor: Shunya Fukuda, Matsumoto-shi (JP)

(73) Assignee: SEIKO EPSON CORPORATION, Tokyo (JP)

(21) Appl. No.: 12/854,374

(22) Filed: Aug. 11, 2010

(30) Foreign Application Priority Data
Aug. 26, 2009 (JP) 2009-195941

(51) Int. Cl. B41J 29/38

(52) U.S. Cl. 347/14

(57) ABSTRACT

A liquid ejecting apparatus includes a head that ejects liquid onto a medium; a head-moving unit that moves the head in a moving direction; a temperature-acquiring unit that acquires a temperature relating to the head; and a control unit that controls the head and the head-moving unit. The control unit corrects an ejection timing of the liquid and causes the head to eject the liquid during forward scanning and backward scanning in the moving direction if the temperature acquired by the temperature-acquiring unit is within a predetermined range. The control unit causes the head to eject the liquid during one of the forward scanning and the backward scanning in the moving direction if the temperature acquired by the temperature-acquiring unit is outside the predetermined range.

### CROSS-REFERENCE TO RELATED APPLICATION(S)

Japanese Patent application No. 2009-195941 is hereby incorporated by reference in its entirety.

### BACKGROUND

1. Field of Invention

The present invention relates to a liquid ejecting apparatus and a liquid ejecting method.

2. Description of Related Art

Ink jet printers that form images by ejecting ink while moving heads are used. Such printers include a printer that forms an image by ejecting ink in both forward and backward scanning directions of a head.

When the printer ejects ink in both directions, an ink-landing position on a medium in the forward scanning direction of the head should be aligned with an ink-landing position on the medium in the backward scanning direction, to increase image quality of an image that is formed on the medium. Owing to this, patterns for inspecting the ink-landing positions in the forward and backward scanning directions are printed. Ejection timings of the ink are corrected on the basis of the patterns. The ink-landing positions in the forward and backward scanning directions are adjusted to be aligned with one another. (For example, see JP-A-2002-205385 and JP-A-2005-138323.)

Even if the ejection timings are corrected during the forward scanning and the backward scanning, it is still difficult to correct the landing positions under an environment with a severe temperature condition, resulting in the image quality being degraded. It is necessary to reduce a shift between the liquid-landing positions under such an environment.

### SUMMARY OF INVENTION

An advantage of some aspects of the invention is to reduce a shift between liquid-landing positions.

According to an aspect of the invention, a liquid ejecting apparatus includes a head that ejects liquid onto a medium; a head-moving unit that moves the head in a moving direction; a temperature-acquiring unit that acquires a temperature relating to the head; and a control unit that controls the head and the head-moving unit. The control unit corrects an ejection timing of the liquid and causes the head to eject the liquid during forward scanning and backward scanning in the moving direction if the temperature acquired by the temperature-acquiring unit is within a predetermined range. The control unit causes the head to eject the liquid during one of the forward scanning and the backward scanning in the moving direction if the temperature acquired by the temperature-acquiring unit is outside the predetermined range.

Other features of the invention will be described in the specification with reference to the attached drawings.

### BRIEF DESCRIPTION OF THE DRAWINGS

The invention will be described with reference to the accompanying drawings, wherein like numbers reference like elements.

FIG. 1 is an explanatory view showing an external configuration of a print system according to an exemplary embodiment.

FIG. 2 is a block diagram showing a general configuration of a printer according to the embodiment.

FIG. 3A briefly illustrates a general configuration of the printer according to the embodiment.

FIG. 3B is a cross-sectional view showing the general configuration of the printer according to the embodiment.

FIG. 4A briefly illustrates a configuration of a linear encoder.

FIG. 4B schematically illustrates a configuration of a detector.

FIG. 5A is a timing chart showing waveforms of two output signals of the detector during forward rotation of a carriage motor.

FIG. 5B is a timing chart showing waveforms of two output signals of the detector during reverse rotation of the carriage motor.

FIG. 6A is an explanatory view showing a structure of a head.

FIG. 6B is an explanatory view showing arrangement of nozzles in a lower surface of the head.

FIG. 7A is an explanatory view showing a drive circuit of a head unit.

FIG. 7B is an explanatory view showing the drive circuit.

FIG. 8 is a timing chart for explaining respective signals.

FIG. 9 is an explanatory view showing ink-landing positions during bidirectional printing.

FIG. 10A is an explanatory view showing a pattern for inspecting a shift between ink-landing positions.

FIG. 10B is an explanatory view showing a pattern after an ejection timing of the ink is adjusted.

FIG. 11A is an explanatory view showing a relationship between an original signal and control signals before the adjustment of the ejection timing of the ink.

FIG. 11B is an explanatory view showing a relationship between the original signal and the control signals after the adjustment of the ejection timing of the ink.

FIG. 12 is a flowchart showing a printing process according to a first embodiment.

FIG. 13 is a flowchart showing a printing process according to a second embodiment.

FIG. 14 is a graph plotting a relationship between a temperature and a viscosity of ink.

FIG. 15 is a table explaining a correction value with respect to a thermistor-detected temperature.

FIG. 16 is an explanatory view showing acquisition of a correction value for a thermistor-detected temperature.

### DESCRIPTION OF THE PREFERRED EMBODIMENTS

With reference to the specification and the attached drawings, at least the following matters will be defined.

A liquid ejecting apparatus includes a head that ejects liquid onto a medium; a head-moving unit that moves the head in a moving direction; a temperature-acquiring unit that acquires a temperature relating to the head; and a control unit that controls the head and the head-moving unit. The control unit corrects an ejection timing of the liquid and causes the head to eject the liquid during forward scanning and backward scanning in the moving direction if the temperature acquired by the temperature-acquiring unit is within a predetermined range. The control unit causes the head to eject the liquid during one of the forward scanning and the backward scanning in the moving direction if the temperature acquired by the temperature-acquiring unit is outside the predetermined range.

Accordingly, a shift between liquid-landing positions can be reduced.

In the liquid ejecting apparatus, it may be determined whether the temperature is within the predetermined range, for each page of the medium. Accordingly, the ejection timing is not changed from the middle of a page of the medium, and hence image quality can be prevented from being changed.

Also, the control unit may determine whether an image to be formed on the medium contains a line if the temperature is outside the predetermined range, and the control unit may cause the head to eject the liquid during one of the forward scanning and the backward scanning in the moving direction if the image contains the line. Further, the line may extend in a direction intersecting with the moving direction. Accordingly, even if the temperature relating to the head is outside the predetermined range, the head can eject the liquid during the forward scanning and the backward scanning as long as the image does not contain the line. Thus, a printing speed can be increased.

Further, the head may include a plurality of nozzle arrays that eject liquid of a plurality of colors, and the ejection timing of the liquid when the head ejects the liquid during the forward scanning and the backward scanning may be corrected, for each of the nozzle arrays. Accordingly, even if liquid with different viscosities depending on nozzle arrays is ejected, the liquid can be ejected at ejection timings suitable for each of the nozzle arrays.

Further, the ejection timing of the liquid may be corrected when the head ejects the liquid during one of the forward scanning and the backward scanning. Accordingly, even if the liquid is ejected during one of the forward scanning and the backward scanning, the liquid-landing position can be adjusted in the moving direction by correcting the ejection timing.

Further, a correction value that corrects the ejection timing of the liquid may be determined in accordance with the temperature relating to the head when the head ejects the liquid during one of the forward scanning and the backward scanning. Accordingly, the ejection timing can be corrected in accordance with the viscosity of the liquid, the viscosity which changes with temperature.

A liquid ejecting method includes acquiring a temperature relating to a head that ejects liquid onto a medium; correcting an ejection timing of the liquid and causing the head to eject the liquid during forward scanning and backward scanning in a moving direction of the head if the temperature relating to the head is within a predetermined range; and causing the head to eject the liquid during one of the forward scanning and the backward scanning in the moving direction of the head if the temperature relating to the head is outside the predetermined range.

Accordingly, a shift between liquid-landing positions can be reduced.

### Exemplary Embodiment

### Configuration of Print System

An exemplary embodiment of a print system (computer system) will be described below with reference to the attached drawings. It is to be noted that the following embodiments include embodiments of a computer program and a storage medium storing a computer program.

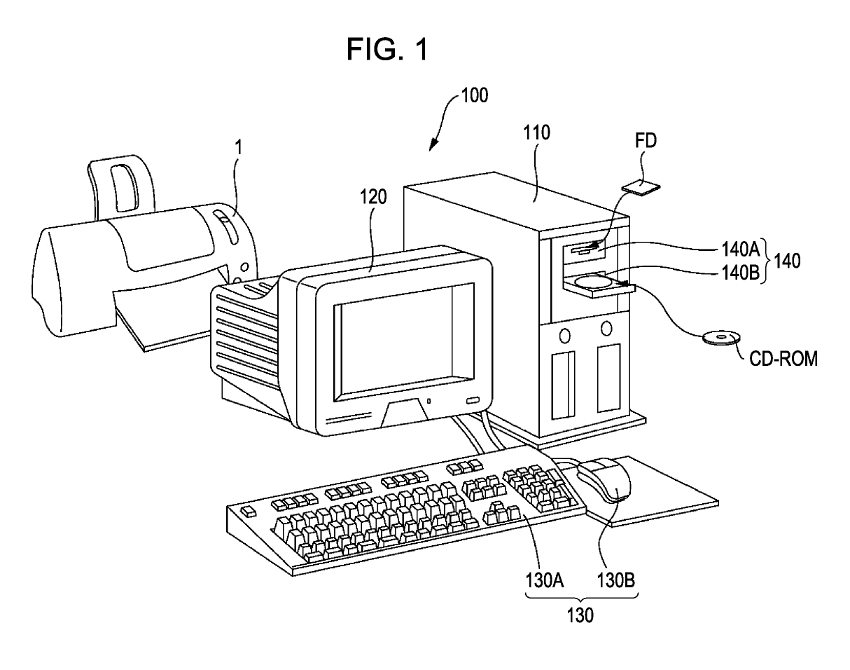

FIG. 1 is an explanatory view showing an external configuration of a print system 100. The print system 100 includes a printer 1, a computer 10, a display device 120, an input device 130, and a recording and reproducing device 140. The printer 1 is a printing device that prints an image on a medium, such as a sheet of paper, a piece of cloth, or a film. A computer 110 is electrically connected to the printer 1. To cause the printer 1 to print an image, the computer 110 outputs print data to the printer 1. The print data corresponds to the image to be printed. The display device 120 includes a display, and displays user interfaces of, for example, an application program and a printer driver. The input device 130 includes, for example, a keyboard 130A and a mouse 130B. The input device 130 is used for operating the application program and for setting the printer driver with the user interfaces displayed on the display device 120. The recording and reproducing device 140 includes, for example, a flexible disk drive 140A and a CD-ROM drive 140B.

A printer driver is installed in the computer 110. The printer driver is a program that provides a function for causing the display device 120 to display the user interfaces, and a function for converting image data output from the application program into print data. The printer driver is stored in a storage medium (a computer-readable storage medium), such as a flexible disk (FD) or a CD-ROM. Alternatively, the printer driver may be downloaded to the computer 110 through the Internet. The program includes codes for providing the functions.

“The printing device” is the printer 1 in a narrow sense, but is a system including the printer 1 and the computer 110 in a broad sense.

Configuration of Ink Jet Printer

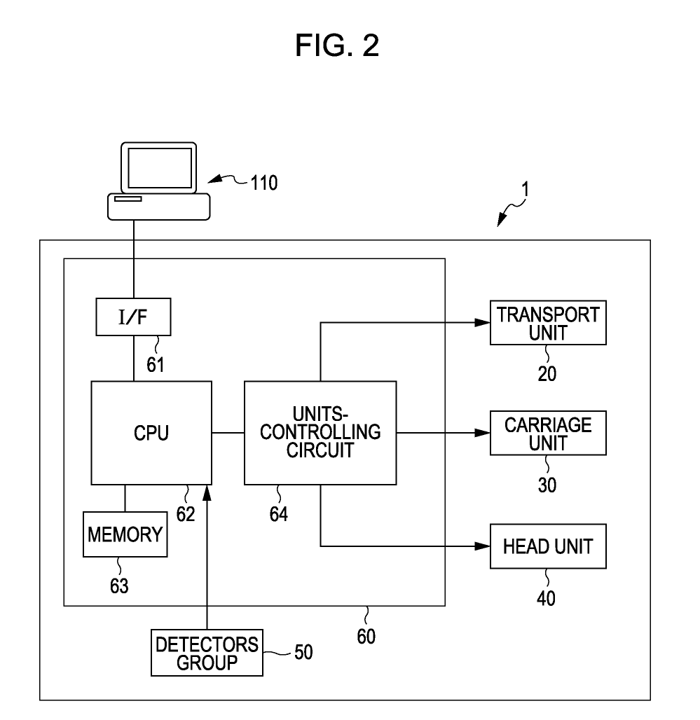

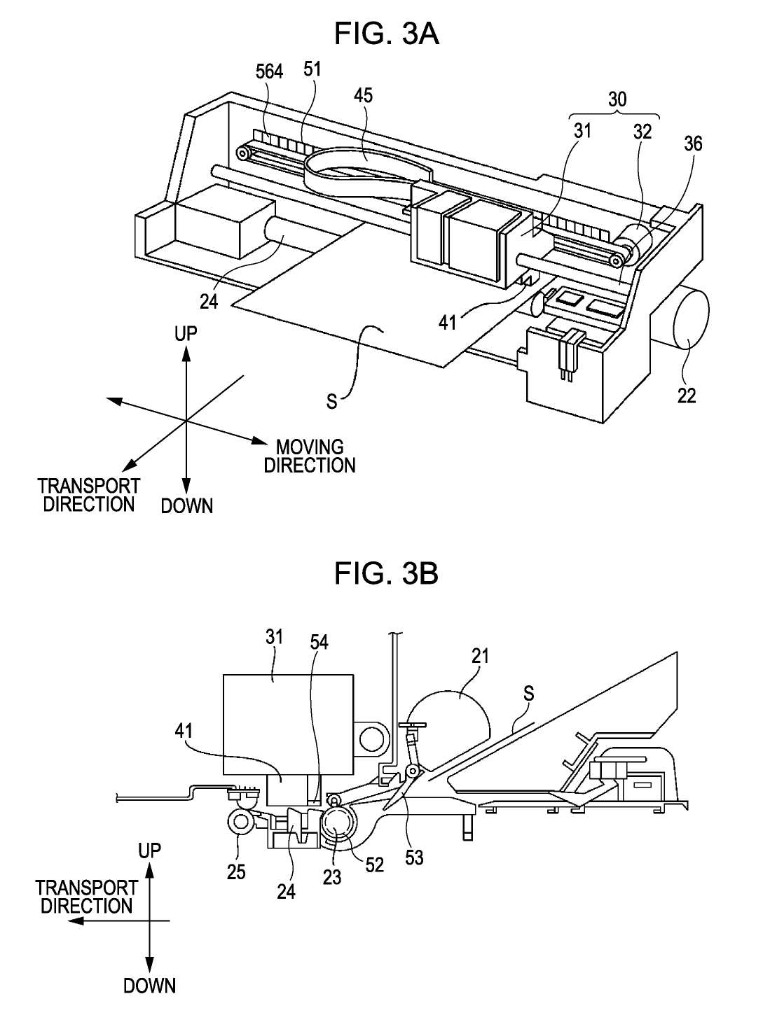

FIG. 2 is a block diagram showing a general configuration of the printer 1 according to this embodiment. FIG. 3A briefly illustrates the general configuration of the printer 1 according to the embodiment. FIG. 3B is a cross-sectional view showing the general configuration of the printer 1 according to the embodiment. A basic configuration of the printer 1 according to this embodiment will be described below.

The printer 1 according to this embodiment includes a transport unit 20, a carriage unit 30, a head unit 40, a detectors group 50, and a controller 60. The printer 1 that has received the print data from the computer 110, which serves as an external device, uses the controller 60 to control the respective units (the transport unit 20, the carriage unit 30, and the head unit 40). The controller 60 controls the respective units in accordance with the print data received from the computer 110, to form an image on a sheet. The detectors group 50 monitors the state in the printer 1. The detectors group 50 outputs the detection result to the controller 60. When the controller 60 receives the detection result from the detectors group 50, the controller 60 controls the respective units on the basis of the detection result.

The transport unit 20 feeds a medium (for example, sheet S) to a printable position, and transports the medium in a predetermined direction (hereinafter, referred to as transport direction) at a predetermined transport rate during printing. That is, the transport unit 20 functions as a transport mechanism that transports a sheet. The transport unit 20 includes a sheet-feed roller 21, a transport motor 22 (also referred to as PF motor), a transport roller 23, a platen 24, and a sheet-output roller 25. However, when the transport unit 20 functions as the transport mechanism, not all the components are required. The sheet-feed roller 21 automatically feeds a sheet, which has been inserted to a sheet insertion port, into the printer 1. The sheet-feed roller 21 has a D-shaped cross section. The sheet-feed roller 21 has a larger length of a circumferential portion than a transport distance from the sheet-feed roller 21 to the transport roller 23. Hence, the sheet-feed roller 21 can transport a sheet S to the transport roller 23 by using the circumferential portion. The transport motor 22 is a DC motor, and transports the sheet S in the transport direction. The transport roller 23 transports the sheet S, which has been fed by the sheet-feed roller 21, to a printable region. The transport roller 23 is driven by the transport motor 22. The platen 24 supports the sheet S during the printing. The sheet-output roller 25 outputs the sheet S outside the printer 1 after the printing. The sheet-output roller 25 rotates synchronously with the transport roller 23.

The carriage unit 30 moves a head (scans with a head) in a predetermined direction (hereinafter, referred to as moving direction). The carriage unit 30 includes a carriage 31 and a carriage motor 32 (also referred to as CR motor). The carriage 31 can reciprocate in the moving direction (accordingly, the head moves in the moving direction). Also, the carriage 31 detachably holds an ink cartridge containing ink. The carriage motor 32 is a DC motor, and moves the carriage 31 in the moving direction.

The head unit 40 ejects ink on a sheet. The head unit 40 includes a head 41. The head 41 has a plurality of nozzles serving as ink ejection portions. The nozzles intermittently eject ink. The head 41 is provided on the carriage 31. Hence, when the carriage 31 moves in the moving direction, the head 41 also moves in the moving direction. If the head 41 intermittently ejects the ink while the head 41 moves in the moving direction, a dot line (raster line) is formed on a sheet in the moving direction. The head unit 40 acquires data for driving the head 41 from the controller 60 in a printer body through a cable 45. The cable 45 is a flexible and flat cable, and is electrically connected to the printer body and the carriage 31.

The detectors group 50 includes a linear encoder 51, a rotary encoder 52, a sheet-detecting sensor 53, an optical sensor 54, etc. The linear encoder 51 detects the position of the carriage 31 in the moving direction. The rotary encoder 52 detects a rotating amount of the transport roller 23. The sheet-detecting sensor 53 detects the position of the leading edge of the sheet to be printed. The sheet-detecting sensor 53 is provided at a position at which the sheet-detecting sensor 53 can detect the position of the leading edge of the sheet while the sheet-feed roller 21 feeds the sheet toward the transport roller 23. The sheet-detecting sensor 53 is a mechanical sensor that detects the leading edge of the sheet by using a mechanical mechanism. To be more specific, the sheet-detecting sensor 53 includes a lever that is rotatable in the transport direction. The lever is arranged to protrude into a transport path. Thus, the leading edge of the sheet contacts the lever, and rotates the lever. The sheet-detecting sensor 53 detects the motion of the lever, and detects the position of the leading edge of the sheet. The optical sensor 54 is attached to the carriage 31. The optical sensor 54 detects the presence of the sheet. In particular, the optical sensor 54 includes a light-emitting portion and a light-receiving portion, and detects the presence of the sheet Such that the light emitting portion irradiates the sheet with light and the light receiving portion detects the reflected light. The optical sensor 54 detects the position of the edge of the sheet while the optical sensor 54 is moved by the carriage 31. The optical sensor 54 optically detects the edge of the sheet. Hence, the optical sensor 54 has a higher detection accuracy than the mechanical sheet-detecting sensor 53.

The controller 60 is a control unit that controls the printer 1. The controller 60 includes an interface (I/F) unit 61, a CPU 62, a memory 63, and a units-controlling circuit 64. The interface unit 61 enables data transmission between the computer 110, which serves as the external device, and the printer 1. The CPU 62 is a processing unit that controls the entire printer 1. The memory 63 provides a storage area for a program of the CPU 62 and a work area for the CPU 62. The memory 63 includes a storage unit, such as a RAM or an electrically erasable programmable read-only memory (EEPROM). The CPU 62 controls the respective units through the units-controlling circuit 64 in accordance with the program stored in the memory 63.

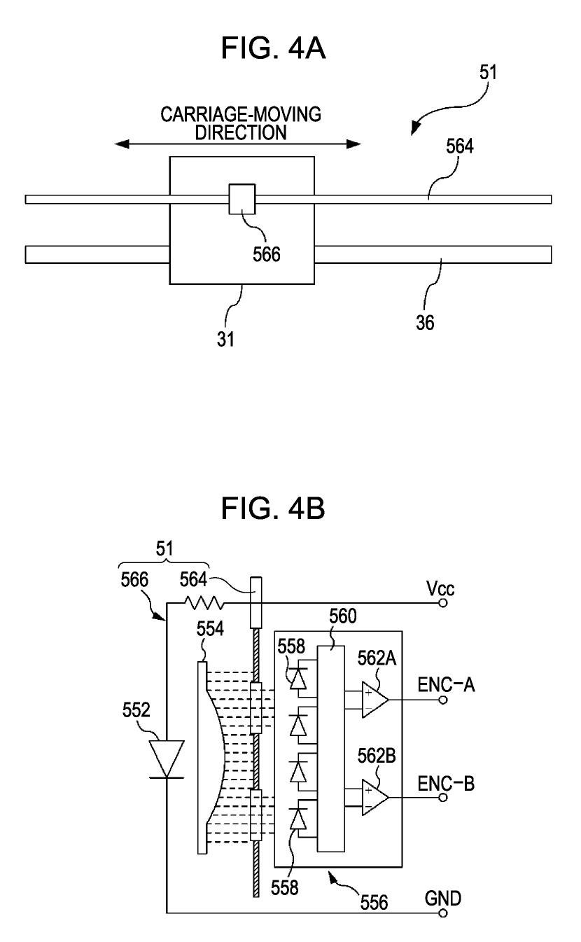

FIG. 4A briefly illustrates a configuration of the linear encoder 51. The linear encoder 51 includes a linear-encoder code disc 564 and a detector 566. Referring to FIG. 3A, the linear-encoder code disc 564 is attached to a frame in the ink jet printer 1. The detector 566 is attached to the carriage 31. If the carriage 31 moves along a guide rail 36, the detector 566 moves along the linear-encoder code disc 564 relative to the linear-encoder code disc 564. Thus, the detector 566 detects a moving amount of the carriage 31.

Configuration of Detector

FIG. 4B schematically illustrates a configuration of the detector 566. The detector 566 includes a light-emitting diode 552, a collimator lens 554, and a detection processing unit 556. The detection processing unit 556 includes a plurality of (for example, four) photodiodes 558, a signal-processing circuit 560, and, for example, two comparators 562A and 562B.

If a voltage Vcc is applied to both ends of the light-emitting diode 552 through resistances, the light-emitting diode 552 emits light. The light is collimated by the collimator lens 554, and passes through the linear-encoder code disc 564. The linear-encoder code disc 564 has slits at a predetermined interval (for example, 1/180 inch, where 1 inch equals to 2.54 cm).

The parallel light (collimated light), which has passed through the linear-encoder code disc 564, passes through a fixed slit (not shown), enters the photodiodes 558, and is converted into an electric signal. Electric signals output from the four photodiodes 558 are processed in the signal-processing circuit 560. The signals output from the signal-processing circuit 560 are compared in the comparators 562A and 562B. The comparison results are output in the form of pulses. The comparator 562A outputs a pulse ENC-A, and the comparator 562B outputs a pulse ENC-B. The pulses ENC-A and ENC-B serve as the outputs from the linear encoder 51.

Output Signal

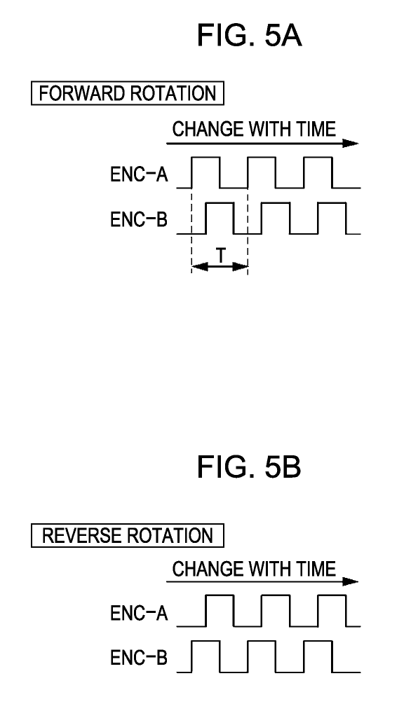

FIGS. 5A and 5B are timing charts showing waveforms of the two output signals from the detector 566 during forward rotation and reverse rotation of the carriage motor 32. Referring to FIGS. 5A and 5B, the phase of the pulse ENC-A differs from the phase of the pulse ENC-B by 90 degrees during the forward rotation and the reverse rotation of the carriage motor 32. When the carriage motor 32 rotates forward, that is, when the carriage 31 moves along the guide rail 36, the phase of the pulse ENC-A is advanced by 90 degrees as compared with the phase of the pulse ENC-B as shown in FIG. 5A. When the carriage motor 32 reversely rotates, the phase of the pulse ENC-A is delayed by 90 degrees as compared with the phase of the pulse ENC-B as shown in FIG. 5B. A single period T of each of the pulse ENC-A and the pulse ENC-B is equivalent to a time in which the carriage 31 is moved by a distance corresponding to the interval of the slits.

Rising edges of each of the output pulses ENC-A and ENC-B of the linear encoder 51 are detected, the number of the detected edges is counted, and the rotational position of the carriage motor 32 is calculated on the basis of the count value. A value “+1” is added to the count value if one edge is detected while the carriage motor 32 rotates forward. A value “−1” is added to the count value if one edge is detected while the carriage motor 32 reversely rotates. The period of each of the pulses ENC-A and ENC-B is equivalent to a time from when a slit of the linear-encoder code disc 564 passes the detector 566 to when the next slit passes the detector 566. Also, the phase of the pulse ENC-A differs from the phase of the pulse ENC-B by 90 degrees. Thus, the count value “1” corresponds to ¼ of the interval of the slits of the linear-encoder code disc 564. By multiplying the count value by ¼, which is the interval of the slits, a moving amount of the carriage motor 32 from a rotational position, at which the count value is “0,” can be obtained on the basis of the multiplication value. At this time, the resolution of the linear encoder 51 is ¼, which is the interval of the slits of the linear-encoder code disc 564.

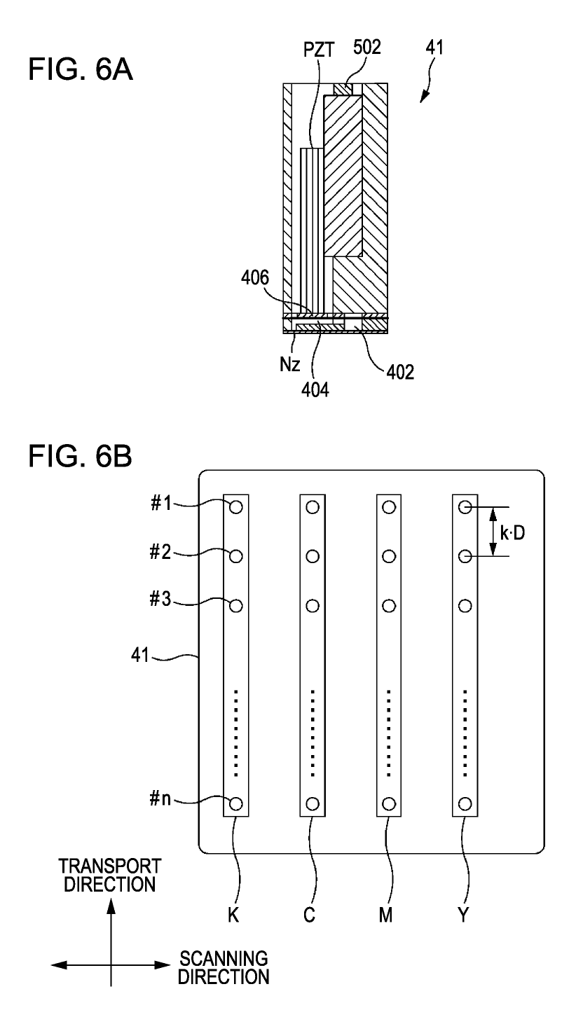

FIG. 6A is an explanatory view showing a structure of the head 41. FIG. 6A illustrates a nozzle Nz, a piezoelectric element PZT, an ink supply channel 402, a nozzle communication channel 404, and an elastic plate 406.

The ink supply channel 402 is supplied with ink from an ink tank (not shown). The ink is supplied to the nozzle communication channel 404. A pulse of a drive signal (described later) is applied to the piezoelectric element PZT. When the pulse is applied, the piezoelectric element PZT expands and contracts in accordance with the signal of the pulse, and vibrates the elastic plate 406. Accordingly, the nozzle Nz ejects ink droplets by a quantity corresponding to the amplitude of the pulse.

Also, a thermistor 502 is attached to the head 41. The temperature of the thermistor 502 is output to the controller 60. Since the thermistor 502 is attached to the head 41, the temperature of the head 41 can be acquired.

Nozzles

FIG. 6B is an explanatory view showing arrangement of nozzles in a lower surface of the head 41. A black-ink nozzle array K, a cyan-ink nozzle array C, a magenta-ink nozzle array M, and a yellow-ink nozzle array Y are formed in the lower surface of the head 41. Each nozzle array has a plurality of nozzles (180 nozzles in this embodiment). Each nozzle serves as an ejection port that ejects ink of each color.

The nozzles in each nozzle array are arranged in the transport direction at a regular interval (nozzle pitch of k·D). D is a minimum dot pitch in the transport direction (that is, an interval of dots formed on a sheet S with a highest resolution), and k is an integer equal to and greater than 1. For example, if the nozzle pitch is 180 dpi ( 1/180 inch), and the dot pitch in the transport direction is 720 bpi ( 1/270 inch), k=4.

Different numbers are assigned to the nozzles in each nozzle array (#1 to #180). A smaller number is assigned to a nozzle located at the downstream side. That is, the nozzle #1 is located downstream of the nozzle #180 in the transport direction. Each nozzle is provided with a piezoelectric element (not shown) serving as a drive element that drives the nozzle to eject ink droplets.

Driving Head

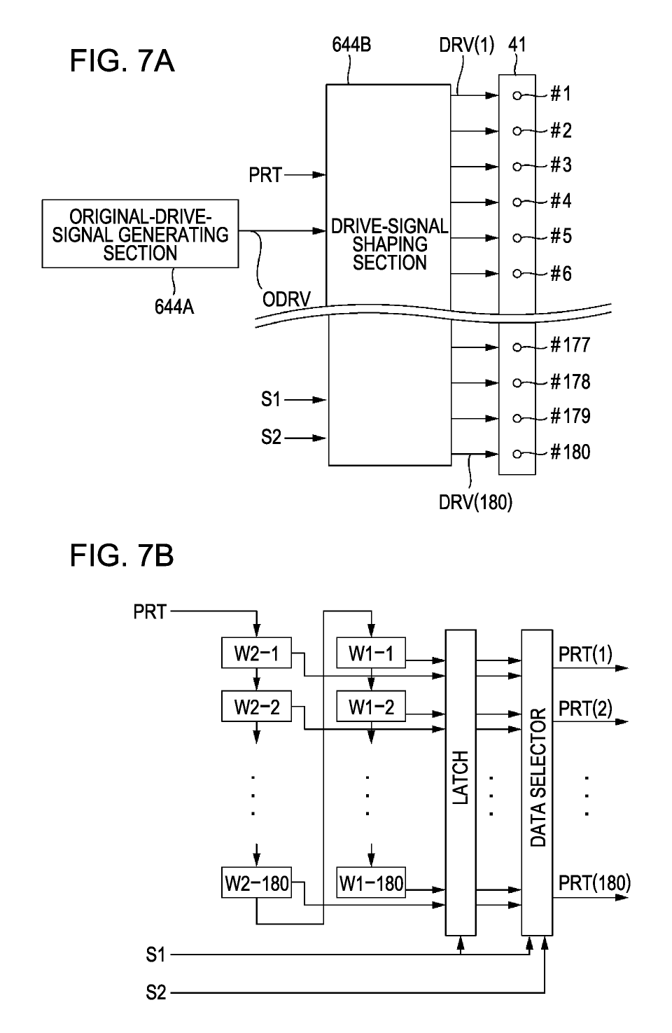

FIG. 7A is an explanatory view showing a drive circuit of the head unit 40. The drive circuit is provided in the units-controlling circuit 64. Referring to FIG. 7A, the drive circuit includes an original-drive-signal generating section 644A and a drive-signal shaping section 644B. The drive circuit for the nozzles #1 to #180 is provided for each nozzle group, that is, for each nozzle array of black (K), cyan (C), magenta (M), and yellow (Y). In addition, each nozzle is driven by the individual piezoelectric element. Referring to FIG. 7A, a number in parentheses at the end of the name of each signal indicates the number of nozzle to which the signal is supplied.

When a voltage with a predetermined time width is applied to electrodes at both ends of the piezoelectric element, the piezoelectric element expands in accordance with the voltage-applied time, and deforms a side wall of an ink flow channel. Accordingly, the volume of the ink flow channel contracts as the piezoelectric element expands. Each of the nozzles #1 to #180 of each color ejects ink droplets by an ink quantity corresponding to the contraction volume of the ink flow channel.

The original-drive-signal generating section 644A generates an original signal ODRV that is commonly used for the nozzles #1 to #180. The original signal ODRV includes a plurality of pulses within a scanning period for a single pixel (i.e., within a time in which the carriage 31 moves across a distance of a single pixel).

The drive-signal shaping section 644B receives the original signal ODRV from the original-drive-signal generating section 644A, and a print signal PRT as serial data.

FIG. 7B is an explanatory view showing the drive circuit. The circuit shown in FIG. 7B performs serial/parallel conversion for the print signal PRT by using 360 shift resistors, so that the print signal PRT is converted into PRT(i) that indicates ON/OFF of each nozzle. The drive-signal shaping section 644B shapes the original signal ODRV in accordance with the level of the print signal PRT(i), and outputs the signal as a drive signal DRV(i) to the piezoelectric element of each of the nozzles #1 to #180. The piezoelectric element of each of the nozzles #1 to #180 is driven in accordance with the drive signal DRV from the drive-signal shaping section 644B.

Drive Signal of Head

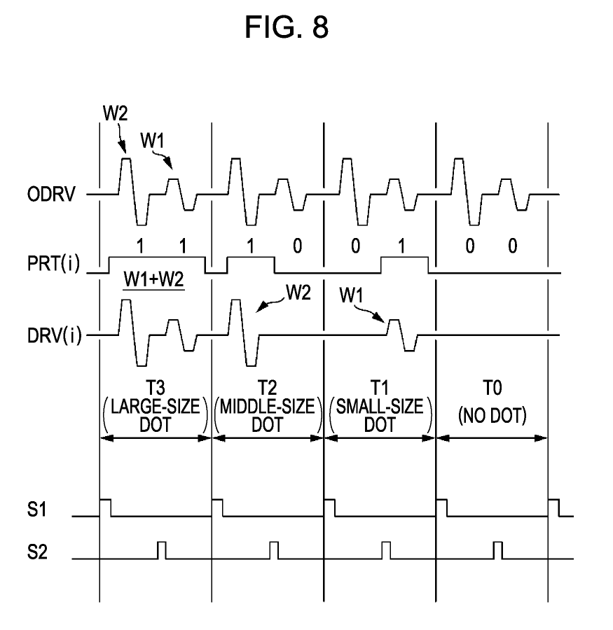

FIG. 8 is a timing chart for explaining respective signals. In particular, FIG. 8 is a timing chart for the respective signals including the original signal ODRV, the print signal PRT(i), and the drive signal DRV(i). The print signal PRT(i) is generated from the print signal PRT.

The original signal ODRV is commonly supplied to the nozzles #1 to #180 from the original-drive-signal generating section 644A. In this embodiment, the original signal ODRV includes two pulses of a first pulse W1 and a second pulse W2 within a main-scanning period for a single pixel (i.e., within a time in which the carriage 31 moves across a distance of a single pixel). The original signal ODRV is output from the original-drive-signal generating section 644A to the drive-signal shaping section 644B.

The print signal PRT(i) corresponds to pixel data that is allocated to a single pixel. That is, the print signal PRT(i) corresponds to pixel data contained in print data. In this embodiment, the print signal PRT(i) includes two-bit information for each pixel. The drive-signal shaping section 644B shapes the original signal ODRV in accordance with the level of the print signal PRT(i), and outputs the drive signal DRV.

The drive signal DRV is obtained when the original signal ODRV is blocked in accordance with the level of the print signal PRT(i). In particular, when the print signal PRT(i) is at a level 1, the drive-signal shaping section 644B allows the pulse corresponding to the original signal ODRV to pass, so that the pulse directly becomes the drive signal DRV. In contrast, when the print signal PRT(i) is at a level 0, the drive-signal shaping section 644B blocks the pulse of the original signal ODRV. The drive-signal shaping section 644B outputs the drive signal DRV to the piezoelectric element provided for each nozzle. Then, the piezoelectric element is driven in accordance with the drive signal DRV.

Referring to FIG. 7B, the control signal S1 is input to a latch circuit and a data selector. The control signal S2 is input to the data selector. Referring to FIG. 8, the control signals S1 and S2 indicate timings at which the print signal PRT(i) is changed.

The serially transmitted print signal PRT is converted into 180 pieces of two-bit data (parallel data) as follows. First, the print signal PRT is input into 360 shift resistors. When the pulse of the control signal S1 is input to the latch circuit, the 360 pieces of data in the respective shift resistors are latched. The data selector selects the data latched in the latch circuit and outputs the selected data. When the pulse of the control signal S1 is input to the latch circuit, the pulse of the control signal S1 is also input to the data selector. When the pulse of the control signal S1 is input to the data selector, the data selector is brought into an initial state. The data selector in the initial state selects the data, which has been stored in a shift resistor W2-i before the data is latched, and the data selector outputs the data as PRT(i). Next, when the pulse of the control signal S2 is input to the data selector, the data selector selects the data, which has been stored in a shift resistor W1-i before the data is latched, and the data selector outputs the data as PRT(i). In this way, the serially transmitted print signal PRT is converted into the 180 pieces of two-bit data. The control signal S1 determines ejection or non-election in association with the second pulse W2. The second signal S2 determines ejection or non-ejection in association with the first pulse W1.

When the print signal PRT(i) corresponds to two-bit data “01,” only the first pulse W1 is output in the latter half of a single pixel period. Accordingly, the nozzle ejects a small-size ink droplet, and hence a small-size dot is formed on a sheet. When the print signal PRT(i) corresponds to two-bit data “10,” only the second pulse W2 is output in the former half of a single pixel period. Accordingly, the nozzle ejects a middle-size ink droplet, and hence a middle-size dot is formed on the sheet. When the print signal PRT(i) corresponds to two-bit data “11,” the first pulse W1 and the second pulse W2 are output in a single pixel period. Accordingly, the nozzle ejects a large-size ink droplet, and hence a large-size dot is formed on the sheet. When the print signal PRT(i) corresponds to two-bit data “00,” the first pulse W1 or the second pulse W2 is not output. Accordingly, the ink is not ejected in a single pixel period, and hence, no dot is formed.

As described above, the drive signal DRV(i) in the single pixel period is shaped so as to have four different waveforms in accordance with the four different values of the print signal PRT(i).

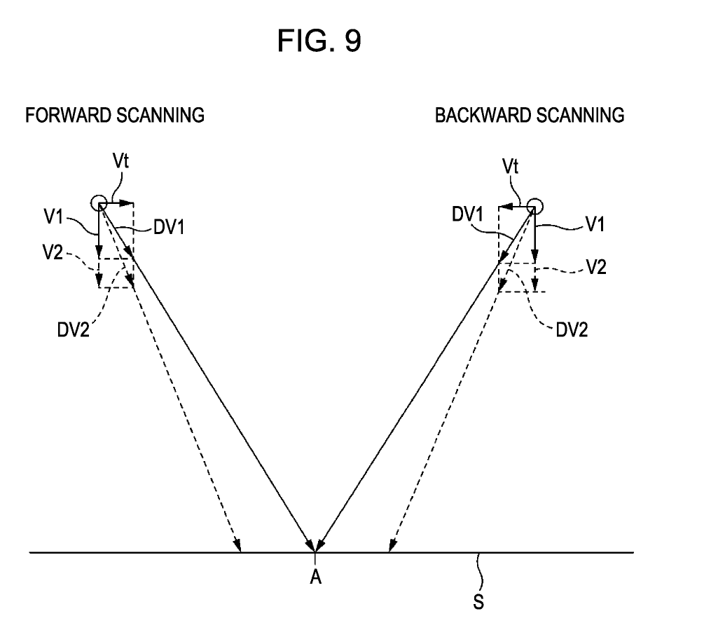

FIG. 9 is an explanatory view showing ink-landing positions during bidirectional printing. FIG. 9 illustrates speeds, at which ink is ejected during the forward scanning and the backward scanning, in the form of vectors. Herein, the head 41 moves at a moving speed Vt during the forward scanning and the backward scanning. In this case, it is desirable to eject the ink onto the sheet S at an ejection speed V1 and to direct the vector of DV1 to a landing position A, so that the ink is ejected onto the landing position A during both the forward scanning and the backward scanning.

However, the ejection speed of the ink may be higher than V1 for some reason. FIG. 9 illustrates an ejection speed V2 of the ink when the ink ejection speed is higher than V1. When the ejection speed is increased, although the ink is ejected at the same timing as the former case, the vector of DV2 is not directed to the position A, resulting in that the ink is landed at a position short of the target landing position A. Then, an ink-landing position during the forward scanning may be shifted from an ink-landing position during the backward scanning in the moving direction of the head 41.

Therefore, the ejection timing has to be adjusted so that the ink-landing position during the forward scanning is aligned with the ink-landing position during the backward scanning.

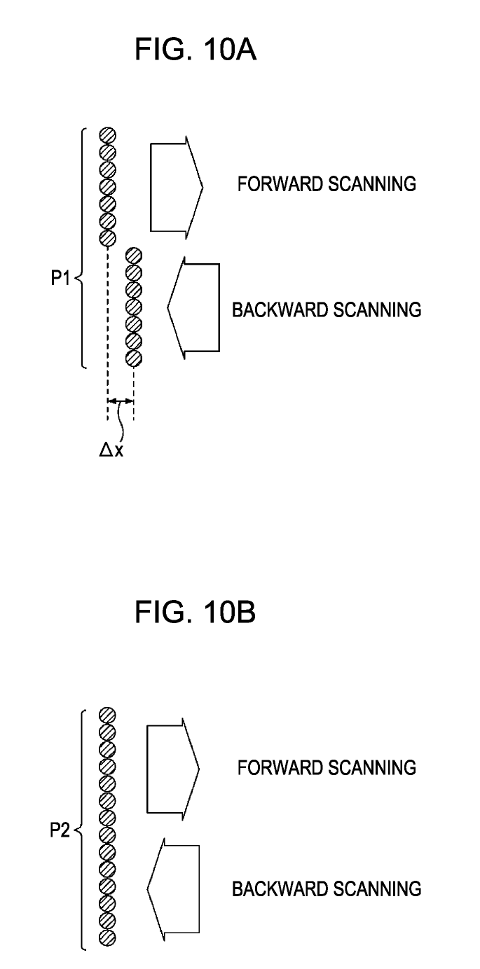

FIG. 10A is an explanatory view showing a pattern for inspecting a shift between ink-landing positions. FIG. 10A illustrates a pattern P1 including a pattern that is formed during the forward scanning and a pattern that is formed during the backward scanning. In both the pattern formed during the forward scanning and the pattern formed during the backward scanning, dots are arranged in a nozzle-array direction, in which the nozzles are arrayed.

The patterns are formed by ejecting the ink at predetermined ejection timings during the forward scanning and the backward scanning of the head 41. However, a line of the pattern during the forward scanning is shifted from a line of the pattern during the backward scanning by Δx in the moving direction of the head 41 because, for example, the ejection speed of the ink is increased as described above. If the shift between the ink-landing positions is obtained (here, Δx), a time, by which the ejection timing should be shifted, can be obtained as long as the moving speed of the head 41 is previously determined.

FIG. 10B is an explanatory view showing a pattern after the ejection timing of the ink is adjusted. In this case, the ejection timing of the ink during the backward scanning is adjusted such that the ink-landing position during the backward scanning is shifted by Δx leftward in FIG. 10B as compared with the case in FIG. 10A. As a result, the landing position of the ink ejected during the forward scanning is aligned with the landing position of the ink ejected during the backward scanning in the moving direction of the head 41.

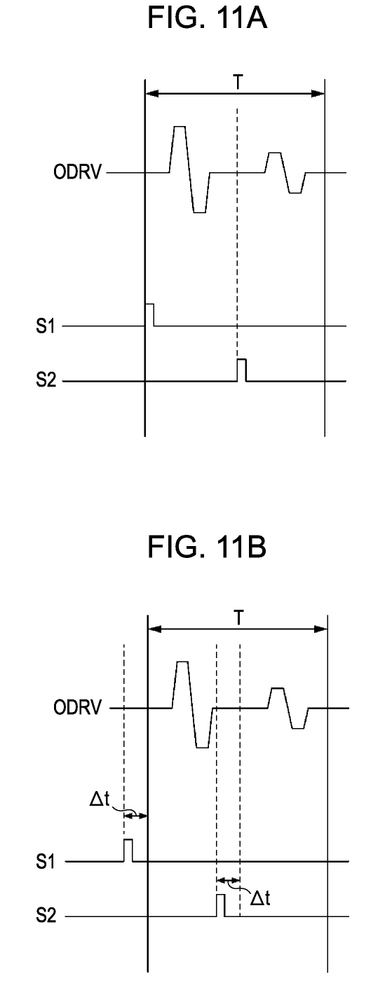

FIG. 11A is an explanatory view showing a relationship between the original signal ODRV and the control signals S1 and S2 before the adjustment of the ejection timing of the ink. FIG. 11A extracts the original signal ODRV and the controls signals S1 and S2 corresponding to the main-scanning period for a single pixel, from the timing chart shown in FIG. 8.

The control signals S1 and S2 are generated on the basis of pulse timing signals (PTS signals). The PTS signals regulate timings at which pulses are generated for the control signals S1 and S2. Pulses of the PTS signals are generated on the basis of the output pulses ENC-A and ENC-B from the linear encoder 51 (the detector 566). That is, a pulse of a PTS signal is generated in accordance with a moving amount of the carriage 31.

Hence, if the generation timing of the original signal ODRV with respect to the control signals S1 and S2 can be shifted, the ejection timing can be changed with respect to the control signals S1 and S2. Also, the ejection timing can be changed with respect to the position of the head 41 on the sheet S in the moving direction.

FIG. 11B is an explanatory view showing a relationship between the original signal ODRV and the control signals S1 and S2 after the adjustment of the ejection timing of the ink. Comparing the shapes of the signals in FIG. 11B to those in FIG. 11A, the shape of the original signal ODRV in FIG. 11B is as the same as that in FIG. 11A. However, the generation timing of the original signal ODRV is delayed by Δt with respect to the control signals S1 and S2, as compared with that in FIG. 11A.

When the generation timing of the original signal ODRV is shifted by Δt, the generation timing of the drive signal DRV is delayed by Δt accordingly. Since the ink is ejected because the drive signal DRV is applied to the piezoelectric element PZT in the head 41, if the generation timing of the drive signal DRV is delayed by Δt, the ejection timing of the ink is delayed by Δt accordingly. In this embodiment, the memory 63 of the printer 1 previously stores Δt as a correction amount of the ejection timing corresponding to Δx shown in FIG. 10A. To delay the ejection timing of the ink by Δt in the backward scanning direction during bidirectional printing, the generation timing of the original signal ODRV is delayed by Δt, so that the landing position during the forward scanning is aligned with the landing position during the backward scanning as shown in FIG. 10B.

To delay the generation timing of the original signal ODRV, the original-drive-signal generating section 644A delays the generation timing of the original signal ODRV.

In the above description, the ejection timing during the backward scanning has been delayed by Δt, however, the ejection timing during the forward scanning may be delayed by Δt, so that the landing position during the forward scanning is aligned with the landing position during the backward scanning as shown in FIG. 10B. Alternatively, the ejection timings during the forward scanning and the backward scanning may be delayed by Δt/2 each, so that the landing position during the forward scanning is aligned with the landing position during the backward scanning as shown in FIG. 10B.

In the above description, the ejection timing of the ink has been delayed. However, the generation timing of the original signal ODRV may be advanced by Δt with respect to the control signals S1 and S2, so that the ejection timing of the ink is advanced.

In the above description, only the single original signal ODRV has been generated. However, if ejection timings are adjusted for ink of a plurality of colors, original signals corresponding to the ink of the plurality of colors may be generated. Then, a generation timing of each original signal with respect to control signals S1 and S2 may be adjusted.

In the above description, the ejection timing of the ink has been adjusted by changing the generation timing of the original signal with respect to the control signals S1 and S2. However, the ejection timing of the ink may be adjusted by changing positions of pixels to be printed in pixel data.

In the above description, only the single correction value has been provided to adjust the ejection timing during the bidirectional printing. However, a plurality of correction values may be provided in accordance with temperatures relating to the head 41.

Although the ejection timing is adjusted by using the above-described correction value, if the temperature of the ink is too high, the viscosity of the ink may be too high, and hence the ejection speed may excessively increase, resulting in that the landing position during the forward scanning may not be aligned with the landing position during the backward scanning even after the ejection timing is delayed. In contrast, if the temperature of the ink is too low, the ejection speed of the ink may be too low, resulting in that the landing position during the forward scanning may not be aligned with the landing position during the backward scanning even after the ejection timing is advanced.

Therefore, in this embodiment, if a temperature relating to the head 41 is within a predetermined range, the ejection timing is corrected and the bidirectional printing is performed, to keep print quality and to increase a printing speed. In contrast, if the temperature relating to the head 41 is outside the predetermined range, since certain print quality is no longer kept during the bidirectional printing, the bidirectional printing is not performed, and the printing is performed by ejecting the ink only during the forward or backward scanning. By ejecting the ink only during the forward or backward scanning, the misalignment between the ink-landing positions during the forward scanning and the backward scanning does not occur. The print quality can be kept even if the temperature is outside the predetermined range.

### First Embodiment

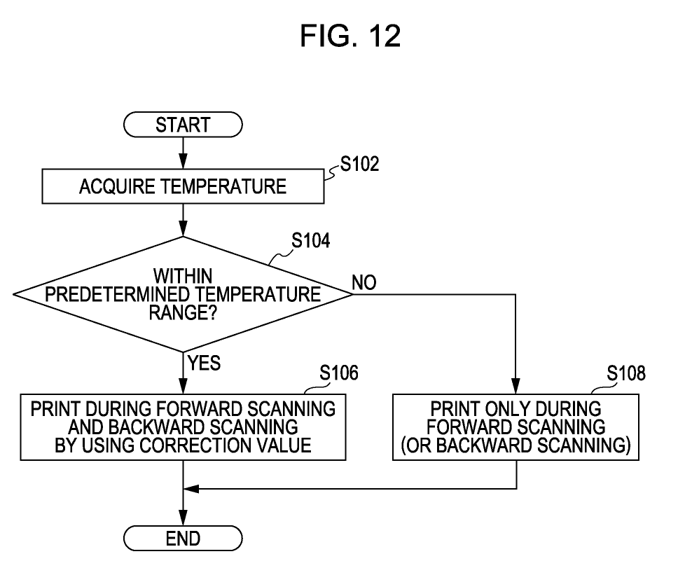

FIG. 12 is a flowchart showing a printing process according to a first embodiment.

When printing is started, a temperature of the head 41 is acquired via the thermistor 502 (S102). The temperature of the head 41 is acquired every sheet S to be printed. In particular, the temperature of the head 41 is acquired immediately before a single sheet S is printed.

Then, it is judged whether the acquired temperature is within a predetermined range (S104). In this embodiment, the predetermined range is from 10° C. to 40° C. If the acquired temperature is within the predetermined range (i.e., in the range from 10° C. to 40° C.), the ejection timing is corrected with the correction value stored in the memory 63 and the printing is performed by ejecting the ink during the forward scanning and the backward scanning (S106). Accordingly, if the temperature is within the predetermined range, the printing speed can be increased by the bidirectional printing.

In contrast, if the acquired temperature is outside the predetermined range, the printing is performed by ejecting the ink only during the forward scanning (or the backward scanning) (S108). Accordingly, in a situation in which it is difficult to align the ink-landing position during the forward scanning with the ink-landing position during the backward scanning although the ejection timing is corrected, the printing is performed by ejecting the ink only during the forward scanning (or the backward scanning), to avoid the misalignment between the ink-landing positions. Thus, the print quality can be kept.

In this way, when the printing for a single sheet S is completed in step S106 or S108, the printing process is ended. If another sheet to be printed is present, the printing process is repeatedly performed.

The printer in this embodiment includes the plurality of nozzle arrays for ejecting the ink of the plurality of colors. Therefore, if the bidirectional printing is performed (S106), the ejection timing is corrected for each of the nozzle arrays.

### Second Embodiment

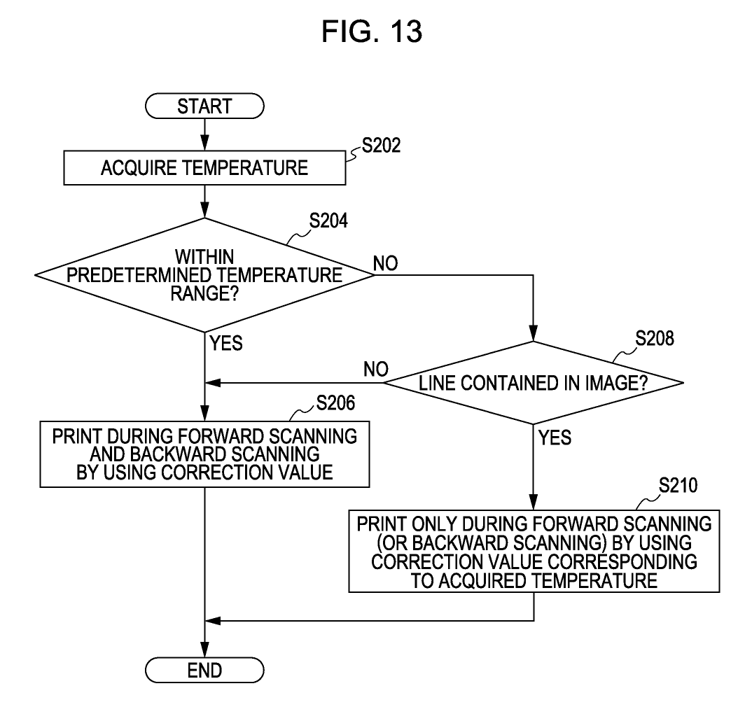

FIG. 13 is a flowchart showing a printing process according to a second embodiment.

In the second embodiment, the control for printing is changed depending on whether an image to be printed contains a line, in addition to the steps described in the first embodiment. Also, when the printing is performed during the forward scanning (or the backward scanning), the temperature relating to the head 41 is acquired, and the ejection timing is corrected even when the printing is performed only during the forward scanning (or the backward scanning) in accordance with the acquired temperature.

When the printing is started, a temperature of the head 41 is acquired via the thermistor 502 (S202). The temperature of the head 41 is acquired every sheet S to be printed.

Then, it is judged whether the acquired temperature is within the predetermined range (S204). If the acquired temperature is within the predetermined range, the ejection timing is corrected with the correction value and the printing is performed by ejecting the ink during the forward scanning and the backward scanning (S206).

In contrast, if the acquired temperature is outside the predetermined range, it is judged whether the image to be printed contains a line (S208). The judgment whether the image contains a line is made, for example, by analyzing pixel data indicative of whether a dot is formed on each pixel in the image to be printed. In particular, this step desirably judges whether the line extends in a direction intersecting with the moving direction of the head 41. That is, this step desirably judges whether the image contains a line extending as shown in FIGS. 10A and 10B.

If the image does not contain a line, the process in step S206 is performed. In particular, the printing is performed by ejecting the ink during the forward scanning and the backward scanning while the ejection timing is corrected with the correction value.

A line (in particular, a line that extends in the direction intersecting with the moving direction) is noticeable if the landing positions are shifted as shown in FIG. 10A. In contrast, if no line is contained, the shift between the landing positions may not be noticeable. Thus, if no line is contained, the printing is desirably performed by ejecting the ink during both the forward scanning and the backward scanning to increase the printing speed. Hence, in the second embodiment, if the image contains no line, the printing is performed by ejecting the ink during both the forward scanning and the backward scanning even if the temperature is outside the predetermined range.

If the image contains the line, the printing is performed by ejecting the ink only during the forward scanning (or the backward scanning) (S210). At this time, the printing is performed while the ejection timing is corrected during the forward scanning (or backward scanning) for ink of each color in accordance with the acquired temperature by the thermistor 502.

When step S206 or S210 is completed, the printing process is ended.

In step S210, even when the printing is performed by ejecting the ink only during the forward scanning, the printing is performed while the ejection timing during the forward scanning is corrected for ink of each color in accordance with the acquired temperature via the thermistor 502 because the following reason.

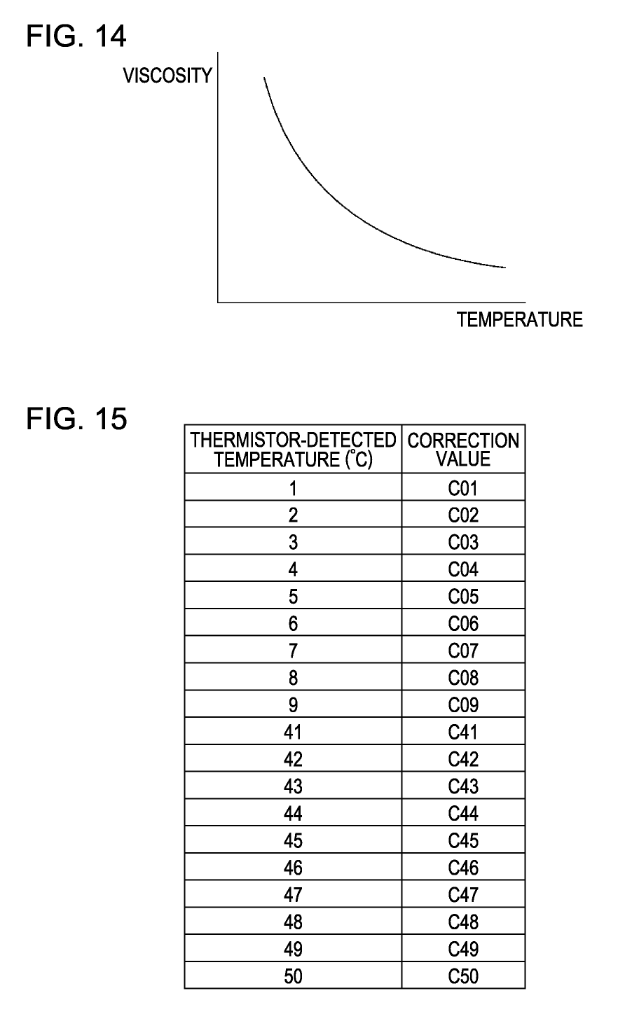

FIG. 14 is a graph plotting a relationship between a temperature and a viscosity of ink. If the temperature of the ink is outside a predetermined range including an ordinary temperature, the rate of change in viscosity with respect to the temperature may be increased (referring to FIG. 14, the rate of change is high particularly when the temperature is low). Also, the rate of change in viscosity of ink with temperature varies depending on the color of ink. Then, when the printing is performed by ejecting the ink only during the forward scanning, the ink-landing positions may be shifted from one another due to the viscosity although the landing positions of the ink of the respective colors should be aligned with one another in the moving direction of the head 41. In particular, if the temperature of the ink is outside the predetermined temperature including the ordinary temperature, the amount of the shift between the landing positions may become large. Then, a color, which is expected to be obtained by superposing the ink of respective colors, is not obtained. The print quality is degraded.

Therefore, even if the printing is performed by ejecting the ink during the forward scanning or the backward scanning, the correction value for the ejection timing with respect to the thermistor-detected temperature (the detected temperature by the thermistor 502) for ink of each color is previously obtained, and the printing is performed while the ejection timing is corrected by using the correction value for ink of each color (for each nozzle array).

FIG. 15 is a table explaining a correction value with respect to a thermistor-detected temperature. In the second embodiment, the correction value for the ejection timing with respect to the thermistor-detected temperature shown in FIG. 15 is previously acquired and stored in the memory 63.

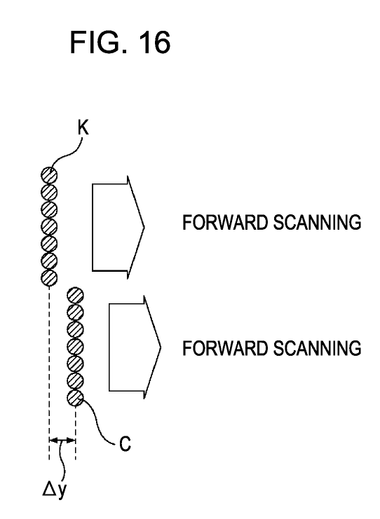

FIG. 16 is an explanatory view showing acquisition of a correction value with respect to a thermistor-detected temperature. Described here is a method of acquiring a correction value for an ejection timing of cyan C with respect to an ejection timing of black K. As illustrated in FIG. 16, ink is ejected from the nozzle array of the black K during first forward scanning, to print a line extending in the direction intersecting with the moving direction of the head 41. Then, the ink is ejected from the nozzle array of the cyan C during the next forward scanning, to print a line extending in the direction intersecting with the moving direction of the head 41.

Then, a shift amount Δy is measured. In this case, since the ejection timing of the cyan C is delayed by Δy, a correction amount, with which the generation timing of the original signal ODRV of cyan C is advanced by Δy, is obtained. The obtained correction amount for each thermistor-detected temperature is stored in the memory 63.

In the above description, the method of obtaining the correction amount for the ejection timing of the cyan C with respect to the ejection timing of the black K has been described. Similarly, correction amounts for magenta M and yellow Y can be obtained.

In this way, if the ink-landing positions are shifted from one another because the viscosity of the ink is changed with temperature, the certain print quality can be kept.

Modifications

In the above-described embodiments, the printer 1 has been described as the liquid ejecting apparatus, however, it is not limited thereto. The apparatus may be implemented by a liquid ejecting apparatus that ejects liquid other than ink (liquid, a liquid-like object in which particles of a functional material are dispersed, or a fluid-like object such as gel). For example, a technique similar to that according to any of the embodiments may be applied to various apparatuses, such as a color-filter manufacturing apparatus, a dyeing apparatus, a microprocessing apparatus, a semiconductor fabricating apparatus, a surface processing apparatus, a three-dimensional molding apparatus, a liquid vaporizing apparatus, an organic electroluminescence (EL) manufacturing apparatus (in particular, a polymer EL manufacturing apparatus), a display manufacturing apparatus, a film forming apparatus, and a DNA-chip manufacturing apparatus, which use the ink jet technique. Also, a method derived from such an apparatus and a manufacturing method of such an apparatus may be included in the range of application.

The embodiments are provided for easy understanding of the invention, but not for interpretation of the invention in a limited way. The invention may be modified and improved within the scope of the invention, and may include equivalents thereof.

Head

In any of the above-described embodiments, the ink has been ejected by using the piezoelectric element. However, the method of ejecting liquid is not limited thereto, and other methods may be used. For example, a method of generating bubbles in a nozzle using heat may be applied.

What is claimed is:

1. A liquid ejecting apparatus comprising:
a head that ejects liquid onto a medium;
a head-moving unit that moves the head in a moving direction;
a temperature-acquiring unit that acquires a temperature relating to the head; and
a control unit that controls the head and the head-moving unit,
wherein the control unit corrects an ejection timing of the liquid and causes the head to eject the liquid during forward scanning and backward scanning in the moving direction if the temperature acquired by the temperature-acquiring unit is within a predetermined range, and
wherein the control unit causes the head to eject the liquid during one of the forward scanning and the backward scanning in the moving direction if the temperature acquired by the temperature-acquiring unit is outside the predetermined range.

2. The liquid ejecting apparatus according to claim 1, wherein it is determined whether the temperature is within the predetermined range, for each page of the medium.

3. The liquid ejecting apparatus according to claim 1,
wherein the control unit determines whether an image to be formed on the medium contains a line if the temperature is outside the predetermined range, and
wherein the control unit causes the head to eject the liquid during one of the forward scanning and the backward scanning in the moving direction if the image contains the line.

4. The liquid ejecting apparatus according to claim 3, wherein the line extends in a direction intersecting with the moving direction.

5. The liquid ejecting apparatus according to claim 1,
wherein the head includes a plurality of nozzle arrays that eject liquid of a plurality of colors, and
wherein the ejection timing of the liquid when the head ejects the liquid during the forward scanning and the backward scanning is corrected, for each of the nozzle arrays.

6. The liquid ejecting apparatus according to claim 1, wherein the ejection timing of the liquid is corrected when the head ejects the liquid during one of the forward scanning and the backward scanning.

7. The liquid ejecting apparatus according to claim 6, wherein a correction value that corrects the ejection timing of the liquid is determined in accordance with the temperature relating to the head when the head ejects the liquid during one of the forward scanning and the backward scanning.

8. A liquid ejecting method comprising:
acquiring a temperature relating to a head that ejects liquid onto a medium;
correcting an ejection timing of the liquid and causing the head to eject the liquid during forward scanning and backward scanning in a moving direction of the head if the temperature relating to the head is within a predetermined range; and
causing the head to eject the liquid during one of the forward scanning and the backward scanning in the moving direction of the head if the temperature relating to the head is outside the predetermined range.
